(19) United States
(12) Patent Application Publication
(10) Pub. No.: US 2018/0345837 A1
(43) Pub. Date: Dec. 6, 2018

(54) COUPLING UNIT FOR A SUPPORT STRUCTURE

(71) Applicant: Schukra Gerätebau GmbH, Berndorf (AT)

(72) Inventors: Pierrot CATRY, Spiere (BE); Jo PATTYN, Geluwe (BE)

(21) Appl. No.: 15/571,814

(22) PCT Filed: Jun. 11, 2015
(86) PCT No.: PCT/EP2015/063074

§ 371 Date: Nov. 3, 2017

(30) Foreign Application Priority Data
May 22, 2015 (EP) 15169030.2

(51) Int. Cl. B60N 2/66; B60N 2/70; B60N 2/72

(52) U.S. Cl. CPC B60N 2/667; F16B 2/248; B60N 2/72; B60N 2/7094

(57) ABSTRACT

A coupling unit for connecting a support structure to an elongated side member comprises a body and a recess. The recess is configured to receive a wire member of the support structure. The coupling unit is configured to be connected to the elongated side member by a snap fit. The elongated side member may be part of a frame of a seat.

### TECHNICAL FIELD

Various embodiments relate to a coupling unit for connecting a support structure to an elongated side member. In particular, various techniques relate to connecting the coupling unit to the elongated side member by a snap fit.

### BACKGROUND

Support structures for incorporation into a backrest of a seat are known. E.g., in U.S. Pat. No. 5,988,745 a lumbar support device comprising a wire framework is disclosed. The wire framework essentially consists of two lateral side wires and a plurality of transverse wires members or cords. Sometimes, such a support structure is also referred to as a wiremat.

Various techniques of connecting the support structure to an elongated side member of a seat frame of the seat are known. For this, a wire member of the support structure are connected to the elongated side member, e.g., by directly bringing the wire member in contact with the elongated side member. E.g., from U.S. Pat. No. 5,988,745 it is known to terminate the transverse wires in hook-like fingers that are secured to the frame. Sometimes, the connection is established via a plastic coating of the wire member or the elongated side member. The plastic coating is typically achieved by overmolding. Other examples include a tubing process or moving a plastic tube over the hook-like fingers of the wire member.

However, such techniques face certain drawbacks and restrictions. E.g., it may not always be possible to attach a wire member to the elongated member employing a metal-on-metal contact and, at the same time, ensure good fixation, durability, comfort, and noise isolation. Further, hook attachments can lead to unergonomic handling; e.g., where a plurality of wire members of the support structure need to be connected with the elongated side member, individual attachment can be cumbersome, time-consuming, and costly. Where the above-mentioned plastic coating is employed, a deflection functionality of the support structure can be limited.

### SUMMARY

Accordingly, a need exists for advanced techniques of connecting a support structure with an elongated side member. In particular, a need exists for techniques of connecting a support structure with an elongated side member which overcome at least some of the above-mentioned drawbacks and restrictions.

This need is met by the features of the independent claims. The dependent claims define embodiments.

According to an aspect, a coupling unit for connecting a support structure to an elongated side member is provided. The coupling unit comprises a body. The coupling unit further comprises at least one recess. Each one of the at least one recess is configured to receive a wire member of the support structure. The coupling unit is configured to be connected to the elongated side member by a snap fit.

E.g., a passage may be formed in the body. The passage may be shaped to at least partly enclose the elongated side member.

E.g., there may be a plurality of recesses provided; then, a plurality of wire members of the support structure may be received and may be connected via the coupling unit to the elongated side member. In some examples, the coupling unit may comprise two or three recesses.

According to an aspect, a system is provided which comprises a plurality of the coupling units according to a further aspect.

According to an aspect, a method is provided. The method comprises receiving a wire member in a recess of a coupling unit. The method further comprises snap fitting the coupling unit to an elongated side member.

It is to be understood that the features mentioned above and features yet to be explained below can be used not only in the respective combinations indicated, but also in other combinations or in isolation, without departing from the scope of the present invention. Features of the above-mentioned aspects and embodiments may be combined with each other in other embodiments.

### BRIEF DESCRIPTION OF THE DRAWINGS

The foregoing and additional features and effects of the invention will become apparent from the following detailed description when read in conjunction with the accompanying drawings, in which like reference numerals refer to like elements.

FIG. 1 is a perspective view of a lumbar support structure for incorporation in a seat frame of a seat.

FIG. 2 is a schematic side view of a coupling unit for connecting the support structure to an elongated side member of the seat frame according to various embodiments, wherein an open position is illustrated where the coupling unit is not attached to an elongated side member.

FIG. 3 is a schematic side view of the coupling unit of FIG. 2, wherein the coupling unit is being snap fitted to a tubular elongated side member, wherein a position of maximum deformation of a body of the coupling unit is illustrated.

FIG. 4A is a schematic side view of the coupling unit of FIG. 2, wherein in an attachment position the snap fit is established, wherein rotational movement is suppressed by two stops.

FIG. 4B is a schematic side view of the coupling unit of FIG. 2, wherein in an attachment position the snap fit is established, wherein rotational movement is limited by two stops.

FIG. 5 is a schematic side view of a coupling unit attached to a plate-shaped elongated side member in an attachment position according to various embodiments.

FIG. 6A is a schematic side view of a coupling unit in an open position, the coupling unit comprising a locking mechanism configured to provide the snap fit by a barb-hook engagement between a first part and a second part of the body of the coupling unit according to various embodiments.

FIG. 6B is a schematic side view of the coupling unit of FIG. 6A in an attachment position.

FIG. 7 is a schematic side view of a coupling unit in an open position according to various embodiments, the coupling unit comprising a connector configured to provide the snap fit by a barb-hook engagement with the elongated side member.

FIG. 8 is a schematic top view of a coupling unit according to various embodiments, wherein the coupling unit comprises a body and a plurality of recesses, wherein each one of the plurality of recesses is configured to receive a wire member of the support structure.

FIG. 9 is a schematic top view of a system comprising a plurality of coupling units according to various embodiments, wherein each one of the plurality of coupling units comprises a body and a recess configured to receive a wire member of the support structure.

FIG. 10 is a perspective view of a wiremat support structure where a plurality of wire members are attached to an elongated side member of a seat frame employing a single coupling unit comprising a plurality of recesses.

FIG. 11 is a detail perspective view of the coupling unit of FIG. 10, wherein details of a mount of the coupling unit for mounting the plurality of wire members to a body of the coupling unit are illustrated.

FIG. 12 is a detail perspective view of the coupling unit of FIG. 10, wherein details of the mount of the coupling unit for attaching the plurality of wire members to a body of the coupling unit are illustrated.

FIG. 13 is a detail perspective view of the coupling unit of FIG. 10, wherein details of a plurality of recesses formed in a body of the coupling unit are shown.

FIG. 14 is a perspective view of a coupling unit attached to a frame according to various embodiments.

FIG. 15 is a flowchart of a method according to various embodiments, wherein a wire member is received in a recess to mount the wire member to the body of the coupling unit before the coupling unit is attached to the elongated side member.

FIG. 16 is a flowchart of a method according to various embodiments, wherein a wire member is received in a recess to mount the wire member to the body of the coupling unit after the coupling unit is attached to the elongated side member.

FIG. 17 is a perspective view of a wiremat back suspension having a plurality of coupling units according to various embodiments.

FIG. 18 is a perspective view of a cushion suspension having a plurality of coupling units according to various embodiments, wherein wiremembers are plastified.

FIG. 19 is a perspective view of a cushion suspension having a plurality of coupling units according to various embodiments, wherein wiremembers are not plastified.

### DETAILED DESCRIPTION

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling.

Hereinafter, techniques are explained which enable ergonomic connection between a support structure, e.g., a lumbar support structure or a wiremat support structure or the like, and an elongated side member. E.g., the elongated side member may be part of a frame. The elongated side member may be a lateral side member or a transversal side member. The elongated side member may be part of a frame, i.e., may be referred to as elongated framing member. The elongated side member may be a top elongated side member, a bottom elongated side member, a left elongated side member, or a right elongated side member. E.g., the elongated side member can be part of a of a seat frame of a seat, of a mattress frame, a furniture frame, etc. E.g., the seat frame may be a frame of a backrest region of the seat; e.g., the seat frame may be frame of a seating region of the seat, i.e., provide a seating cushion. For illustrative purposes, hereinafter reference is primarily made to incorporation of the support structure into a seat. This elongated side member may be plate-shaped or tubular-shaped. It may be part of a back structure or of a cushion structure.

The connection is established by a snap fit. In detail, a coupling unit comprises a body and at least one recess. E.g., the at least one recess may be formed in the body or may be attached to the body.

Each one of the at least one recess is configured to receive a wire member of the support structure. The coupling unit is configured to be connected to the elongated side member by the snap fit.

The snap fit may correspond to a connection between two pieces where, in an attachment position, gripping engagement fixedly secures and attaches the two pieces to one another. To reach the attachment position from an open position, it may be required to exert a given force to flexibly deform at least one of the two pieces. A shape of the two pieces may be configured such that when bringing or pushing the two pieces together, the at least one of the two pieces deforms until, after passing a position of maximum deformation, the previously deformed at least one of the two pieces resiliently relaxes at least partly and snaps into the attachment position. Thus, a resistance may need to be overcome by the deformation. Generally, the snap fit can establish a returnable/releasable connection or a non-returnable connection. Resilient flexibility of the at least one of the two pieces may be due to a shape of the at least one of the two pieces (shape-induced flexibility) and/or due to a material of the at least one of the two pieces (material-induced flexibility).

Generally, the snap fit may suppress movement and/or rotation at least with respect to some degrees of freedom of the two pieces; it is possible that the snap fit does not suppress movement and/or rotation in all degrees of freedom of the two pieces.

By establishing the connection between the support structure and the elongated side member via the coupling unit employing the snap fit, ergonomic and easy-to-handle incorporation of the support structure into the seat can be provided. It may be possible to establish a reliable and endurable connection within short time. In particular, it is possible that the wire member of the support structure is attached to the coupling unit before or after the snap fitting the coupling unit to the elongated side member. This increases a versatility of the assembly and installation process of the seat.

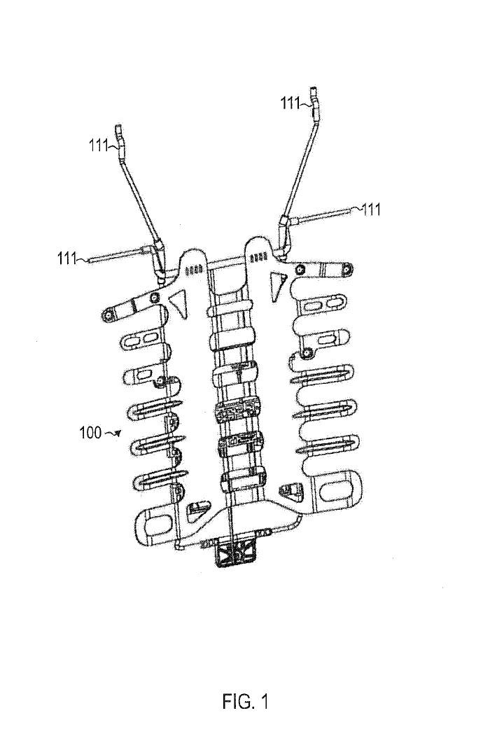

In FIG. 1, aspects of the support structure are explained based on the example of a lumbar support structure. In the example of FIG. 1, the lumbar support structure 100 comprises a so-called support basket having a plurality of resilient fingers for providing support. Other suitable configurations of lumbar support structures, such as support plates or similar, may also be used to implement the lumbar support device 100. The lumbar support structure 100 may be incorporated in a backrest of a seat, e.g., an automotive seat or any other seat.

As can be seen, for installing the support structure 100 in the backrest of the seat, the lumbar support structure 100 comprises lateral and transversal wire members 111. The wire members 111 can be attached to an elongated side member of the frame of the seat (not shown in FIG. 1). Typically, the wire members 111 are comparably rigid such that it is possible to fixedly arrange the lumbar support structure 100 at a given position of the seat.

While in FIG. 1 a lumbar support structure is shown, generally the techniques disclosed herein may be applied to other kinds and types of support structures, e.g., a wiremat support structure (cf. FIG. 17), etc.

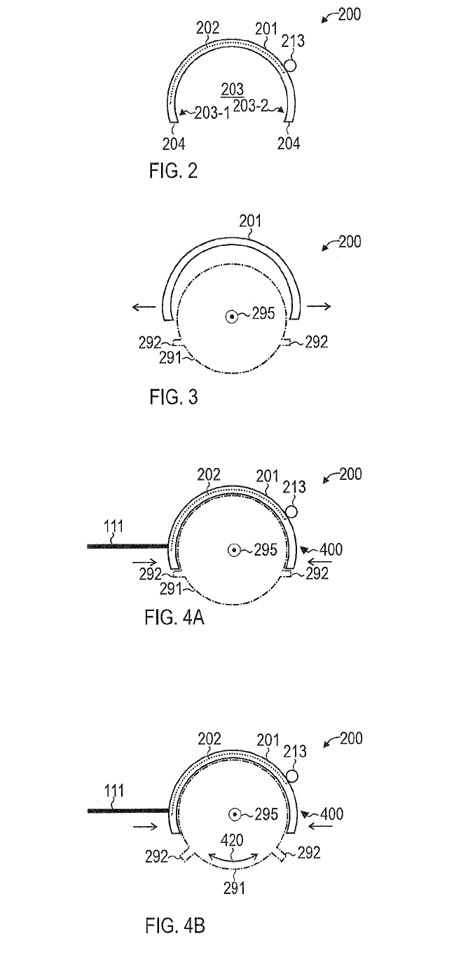

In FIG. 2, structural features of the coupling unit 200 are schematically illustrated. The coupling unit 200 comprises a body 201 and a recess 202; in the scenario of FIG. 2 the recess 202 is formed in the body 201. The recess 202 is configured to receive the wire member 111 of the support structure 100 (not shown in FIG. 2). Ends of the body 201 are formed by flat surfaces 204; the flat surfaces 204 implement stops against which protrusions of the elongated side members (not shown in FIG. 2) can abut. The wire member 111 can be fixedly mounted to a mount 213 of the coupling unit 200. In the example of FIG. 2, the mount 213 is implemented as an eye into which a corresponding hook attached to or formed by an end of the wire member 111 can be engaged.

Generally, different kinds of mounts 213 can be employed. It may be possible that the mount 213 is integrated or at least partly integrated in the body 201 (not shown in FIG. 2). It is also possible that the mount 213 is detachable from the body 201.

In the example of FIG. 2, a passage 203 is formed in the body 201. In detail, the passage 203 is formed by an inner surface of the body 201. The passage 203 is circularly shaped. This allows enclosing the elongated side member tightly if a longitudinal axis of the elongated side member coincides with the center axis of the passage. Relative movement can be suppressed.

In the example of FIG. 2, the body 201 is arc-shaped. In the example of FIG. 2, the body 201 extends at an angle of approximately 220° with respect to a center point of the arc of the arc-shaped body. A wall thickness of the body 201 is comparably limited. Further, a material of the body 201 is plastic. Both (i) the shape and (ii) the material of the body 201 favor resilient flexibility of the body 201; i.e., it is possible to deform the body 201 to a certain degree. In particular, the body 201—being arc-shaped in the example of FIG. 2—is shaped to provide a particularly high flexibility between opposing edges 203-1, 203-2 of the body 201 forming the passage 203.

Thus, the shape-induced and the material-induced flexibility both contribute, in the example of FIG. 2, so that by deformation the opening (depicted in the left-right direction of FIG. 2) towards the passage 203 between opposing edges 203-1, 203-2 can be widened. This finding is relied upon to connect the support structure to the framing by the snap fit. In detail, the shape-induced and material-induced flexibility of the body 201 is relied upon to provide the snap fit.

In FIGS. 3, 4A, 4B aspects of the coupling unit 200 of FIG. 2 are illustrated that relate to the passage 203 and the body 201 being configured to act as a snap-on clip around the elongated side member 291 to provide the snap fit 400. Namely, as can be seen from FIGS. 3 and 4, the passage 203 is shaped to partly enclose the elongated side member 291. In the scenario of FIGS. 3 and 4, the elongated side member 291 has tubular shape.

Hereinafter, details of the snap-on clip functionality of the coupling unit 200 are explained at greater detail. First, in FIG. 3 (for sake of simplicity, in FIG. 3, the mount 213 and the recess 202 are not shown), a situation is schematically illustrated where the coupling unit 200 is brought into contact and slid over and around the elongated side member 291. FIG. 3 corresponds to the position of maximum deformation.

To bring the body 201 of the coupling unit 200 in close contact with the elongated side member 291, it is possible that exertion of a force is required. Here, due to the flexibility of the body 201, the body 201 is deformed outwardly (indicated in FIG. 3 by the outwardly oriented arrows) due to the force pushing the body 201 over and around the elongated member 291. E.g., by exerting a force when snap fitting the passage 203 over and around the elongated side member 291, the passage 203 can be temporarily deformed and widened so that the elongated side member 291 can be inserted.

Second, in FIGS. 4A, 4B, the attachment position is reached. The body 204 is relaxed due to the resilient nature of the material of the body 204 (indicated in FIGS. 4A, 4B by the inwardly oriented arrows). The body 201 is relaxed—albeit, generally, also in the attachment position some residual deformation of the body 201 may be present.

In the attachment position, the snap fit 400 fixedly attaches the coupling unit 200 to the elongated side member 291. It is possible to release the coupling unit 200 and the elongated side member 291 by exerting sufficient force to deform the body 201 again (cf. FIG. 3); a releasable connection is formed. Due to the arc-shaped form of the body 201 enclosing an angle of more than 180° with respect to a center point of the arc of the arc-shaped body, the body 201 cannot be released from the elongated side member 291 unless deformed accordingly; i.e., in order to release the snap fit 400, the position of maximum the formation (cf. FIG. 3) needs to be overcome again.

In the scenario of FIG. 4A, rotational movement of the coupling unit 200 with respect to the elongated side member 291 is fully limited and suppressed by two protrusions 292 that engage with the contact surfaces 204 of the body 201. Differently, in the scenario of FIG. 4B, rotational movement 420 (illustrated by the curved arrow in FIG. 4B) of the coupling unit 200 with respect to the elongated side member 291 is not suppressed, but still limited due to the protrusions 292 being spaced accordingly.

While in the scenarios of FIGS. 4A and 4B, limitation of the rotational movement by means of the stop implemented by the contact surfaces 204 has been illustrated, similar techniques may be readily applied alternatively or additionally to limit translational movement of the coupling unit 200 with respect to the elongated side member 291. Further, it would also be possible to employ at least one of a protrusion and a notch attached to the body 201 as the stop; hence, implementations of the stop are not limited to the contact surface 204.

Generally, limitation of movement of the coupling unit 200 by implementing stops is optional. Sometimes, it may be desirable to not limit the rotational movement and/or translational movement of the coupling unit 200.

In FIGS. 4A and 4B, the wire member 111 is shown; the wire member 111 is received in the recess 202. As can be seen, the recess 202 is shaped such that it is perpendicularly arranged, in particular tangentially arranged with respect to the longitudinal axis 295 (arranged perpendicular to the drawing plane in FIGS. 2, 3, 4A, and 4B) of the elongated side member 291. In particular, the recess 202 is shaped to extend at an angle of approximately 70°. Because the wire member 111 is not fully wound around the longitudinal axis 295 and the opening to the passage 203 is left open, it is possible to receive the wire 111 in the recess 220 and optionally mount the wire 111 to the coupling unit 200 before the coupling unit 200 is connected to the elongated member 291 and before the snap fit is established.

In FIGS. 2, 3, 4A, and 4B, the body 201 is arc-shaped. Generally, it is not required that the body 201 is arc-shaped. Likewise, in FIGS. 2, 3, 4A, and 4B, the passage 203 is circularly shaped. Generally, it is not required that the passage 203 is circularly shaped. It is possible that the shape of the passage 203 and/or of the body 201 conforms with a shape of the elongated side member 291. E.g., in FIGS. 2, 3, 4A, and 4B, the shape of the passage 203 and of the body 201 is set to conform with the tubular elongated side member 291.

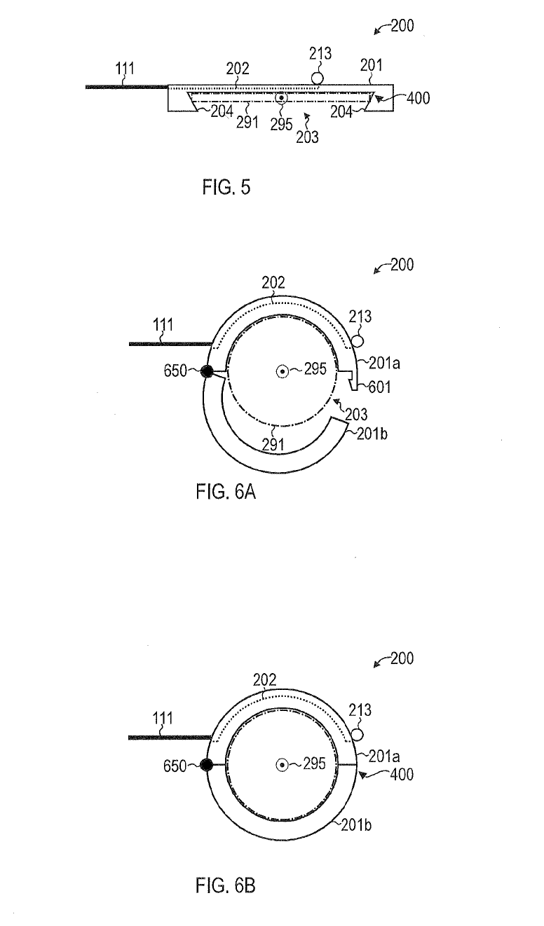

In FIG. 5, a scenario is shown where the body 201 is plate shaped. The passage 203 is shaped to partly enclose the elongated side member 291 having plate shaped. Again, in FIG. 5, due to the shape of the body 201, resilient flexibility is provided that allows to resiliently deform the body 201 so that the body 201 can act as a snap-on clip around the elongated side member 291 to provide the snap fit 400. E.g., by exerting a force when snap fitting the passage 203 over and around the elongated side member 291, the passage 203 can be temporarily deformed and widened so that the elongated side member 291 can be inserted. Also in the scenario of FIG. 5, the recess 202 is shaped such that it is perpendicularly arranged with respect to the longitudinal axis 295 (arranged perpendicular to the drawing plane of FIG. 5) of the elongated side member 291.

In the scenarios of FIGS. 2, 3, 4A, 4B, and 5, the flexibility of the body 201 that is relied upon to provide the snap fit 400 is achieved by shape-induced flexibility and/or material-induced flexibility, as explained above. In these scenarios, the body 201 acts as a snap-on clip around the elongated side member 291 to provide the snap fit 400.

In FIGS. 6A, 6B, a different scenario is shown. Here, it is possible that the material of the body 201 does not possess significant elasticity, e.g., if compared to the scenarios as discussed above. Hence, in other words, it is possible that the material of the body 201 is comparably rigid and does not allow or only allow to an insignificant degree for resilient deformation. E.g., a material of the body 201 can comprise metal.

In the scenarios of FIGS. 6A, 6B a first part 201A of the body is rotatable around a hinge 650 with respect to a second part 201B of the body 201B. By rotating the first and second parts 201A, 201B around the hinge 650, in the open position of FIG. 6A an opening to the passage 203 can be created such that the coupling unit 200 can be slid over and around the elongated side member 291. Then, the snap fit 400 is provided by a locking mechanism 601. FIG. 6A illustrates the open position while of FIG. 6B illustrates the attachment position. In the attachment position, the first part 201A and the second part 201B are connected with each other via the locking mechanism 601. The locking mechanism 601 is configured to connect a first part 201A and a second part 201B of the body 201 by the snap fit 400; in particular, the locking mechanism 601 is configured to provide the snap fit 400 by a barb-hook engagement between the first part 201A and the second part 201B of the body 201. E.g., the locking mechanism 601 may be made of a resiliently deformable material such as plastic.

In the scenario of FIGS. 6A, 6B, the body 201 is shaped to fully enclose the elongated side member 291. Thereby, the connection between the wire member 111 and the elongated side member 291 can be particularly robust. Also in the scenarios of FIGS. 6A, 6B it is possible to receive the wire member 111 in the recess 202 before or after snap fitting the two parts 201A, 201B of the body 201 together.

While in the scenario of FIGS. 6A, 6B, the elongated side member 291 is of tubular shaped, it is also possible to implement the locking mechanism 601 in a scenario where, e.g., the elongated side member 291 is plate shaped or of any other shape.

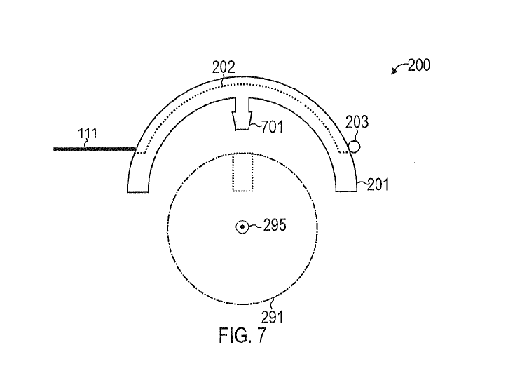

Yet a further scenario is illustrated in FIG. 7. In FIG. 7, the coupling 200 comprises a connector 701. The connector 701 is attached to the body 201 and is configured to provide the snap fit 400 by a barb-hook engagement with the elongated side member 291 directly. In such a scenario, it is possible that the body 201 is dimensioned comparably small-scale. Again, this implementation of the snap fit 400 is not limited to the particular shape of the elongated side member 291 and of the body 201.

In some scenarios, it may be sufficient to connect individual wire members 111 of the support structure to the elongated side member 291 of the seat frame. Then, it is possible that the coupling unit 200 comprises a single recess 202. However, sometimes, it can be desirable to attach a plurality of wire members 111 of the support structure 100 to the elongated side member 291. Here, various implementations are conceivable. Hereinafter, aspects of connecting a plurality of wire members 111 to the elongated side member 291 are discussed. These aspects may be employed for different shapes and types of the elongated side member 291 and/or the body 201, etc. These aspects may be employed for different types of the snap fit 400.

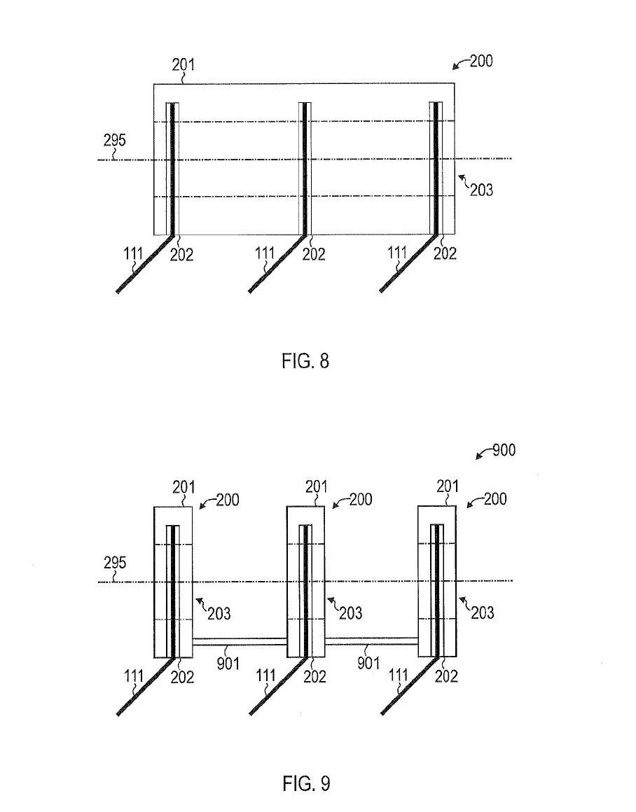

In FIG. 8, aspects of attaching a plurality of wire members 111 to the elongated side member 291 according to an embodiment are illustrated. In the example of FIG. 8, the coupling unit 200 comprises a plurality of recesses 202; while, specifically, in FIG. 8, three recesses 202 that are perpendicularly arranged with respect to the longitudinal axis 295 of the elongated side member 291 are shown, generally, a larger or smaller number of recesses 202 can be provided. In the scenario FIG. 8, it is possible to connect the plurality of wire members 111 in a single snap fit action to the elongated side member 291.

In FIG. 9, aspects of attaching the plurality of wire members 111 to the elongated side member 291 according to a further embodiment are illustrated. In the example of FIG. 8, the individual coupling units 200 are provided as a system 900, wherein, per coupling unit 200, a single recess 202 is provided. I.e., per coupling unit 200, a single wire member 111 is connected to the elongated side member 291. In the scenario of FIG. 9, it is required to execute three snap fit actions, i.e., one snap fit action per coupling unit 200.

Further shown in FIG. 9 is an elongated joint 901. The elongated joined 901 is optional. The elongated joined 901 extends in parallel to the longitudinal axis 295 of the elongated side member 291. The elongated joined 901 is configured to connect the plurality of coupling units 201 with each other. The elongated joint 901 ensures that the wire members 111 are arranged at a fixed distance with respect to each other; in particular, the elongated joined 901 can limit or suppress translational movement of the coupling units 200 with respect to each other and with respect to the elongated side member 291.

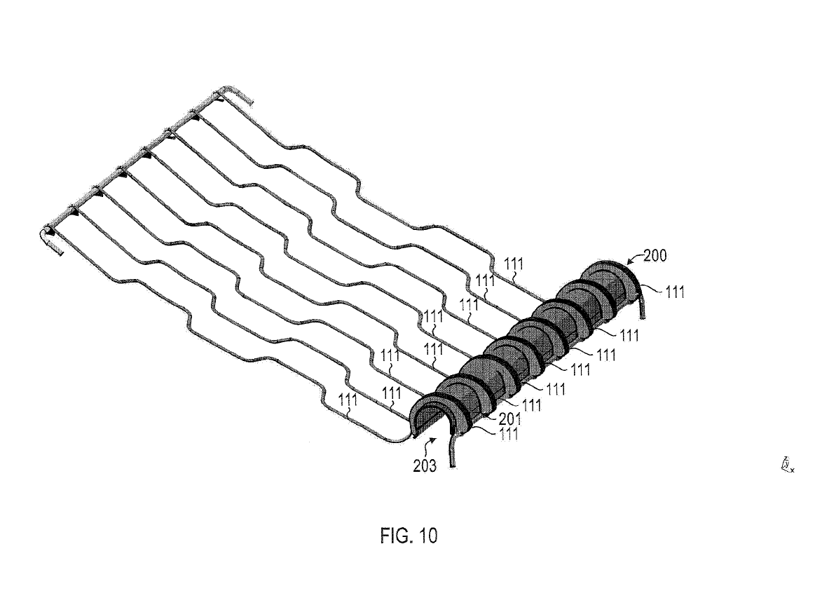

While above various scenarios have been discussed with respect to a lumbar support structure 100, it is possible to readily employ corresponding techniques to other kinds and types of support structures 100. E.g., referring to FIG. 10, techniques of connecting a wiremat support structure 100 comprising a plurality of transverse wire members 111 to the elongated side member 291 of a seat frame 1000 of a seat are illustrated. Here, in a manner comparable to the scenario discussed above with respect to FIG. 8, a plurality of recesses 202 are formed in the body 201 of the coupling unit 200. Thereby, by executing a single snap fit action, it is possible to connect the entire wiremat support structure 100 to the elongated side member 291.

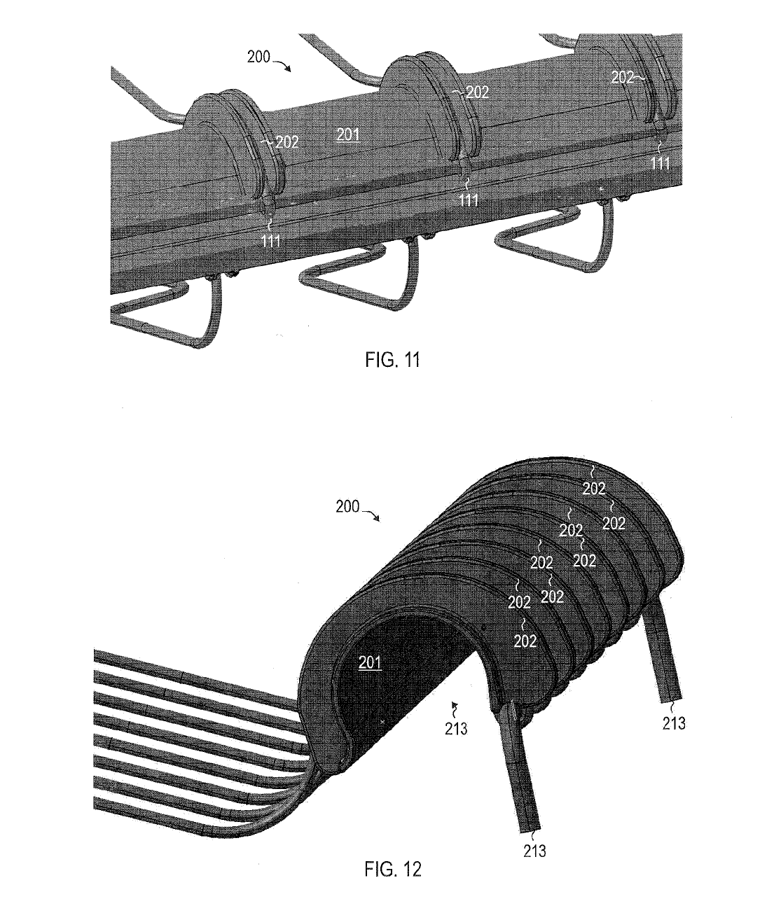

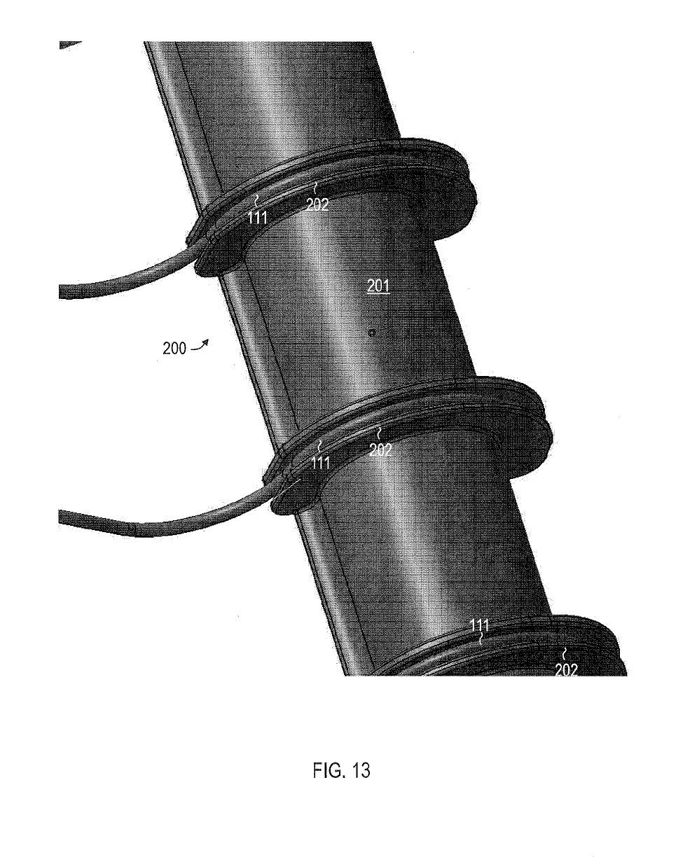

Making reference to FIGS. 11 and 12, details of attaching the wire members 111 of the support structure 100 to the body 201 are illustrated. Here, the wire members 111 are received in the recesses 202; at one end of the recesses 202, the wire members 111 are formed to provide eyes through which a rod acting as a mount 213 can be inserted. Hence, in other words, the wire members 111 are turned or bent around the rod implementing the mount 213. E.g., it is possible that the wire members 111 are formed as knots through which the rod 213 can be inserted.

From FIG. 12, it can be seen that preferably the rod 213 is shaped such that a contact between the rod 213 and the elongated side member 291 is avoided. E.g., it is possible that, both, the mount 213 and the elongated side member 291 are made of metal; then, it can be desirable to avoid a metal-to-metal contact.

In FIG. 13, aspects of the recess(es) 202 are discussed. In the example of FIG. 13, the recesses 202 are formed in protrusions of the body 201. Generally, it is possible that the recesses 202 themselves provide a snap-in clip functionality to the wire members 111; i.e., it is possible that each one of the plurality of recesses 202 is configured to receive the respective wire member 111 by a further snap fit. Thereby, reliable attachment of the wire members 111 to the recesses 202 can be ensured. In particular, it can be avoided that a wire member 111 loosens and projects out of the recess 202.

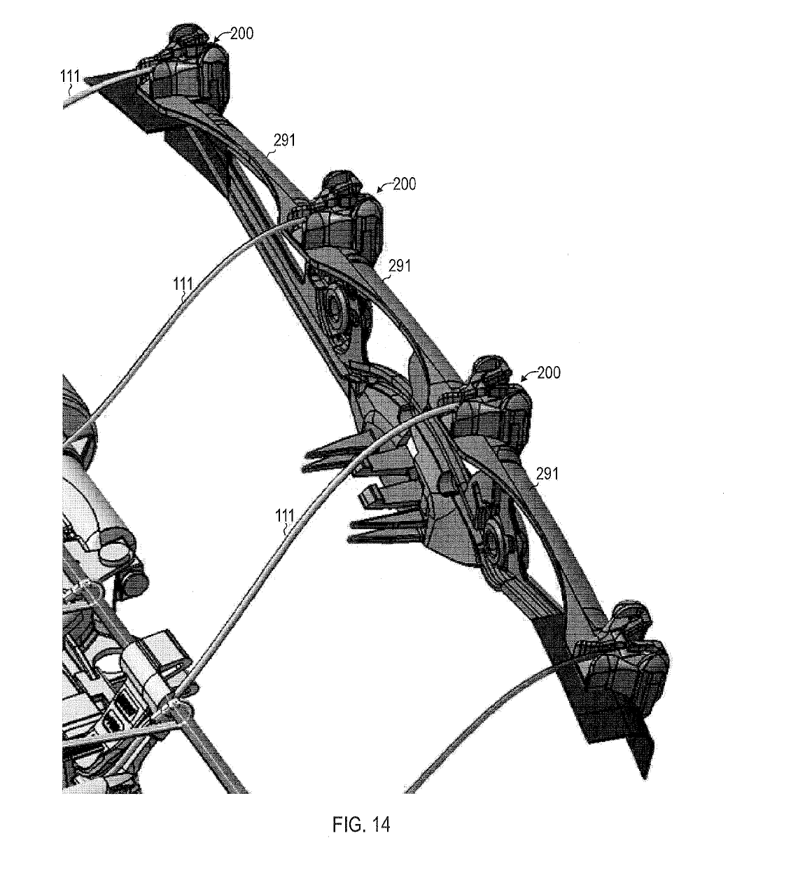

In FIG. 14 aspects are illustrated for attachment of a plurality of coupling units 200 to an elongated side member of a plate frame; here the elongated side member 291 is not of tubular shape, but more of a plate-like shape. Here, attachment by the snap fit 400 can be established, e.g., via a connector 701 as discussed with respect to FIG. 7. Other kinds and types of snap fits can be used as well, e.g., as discussed with respect to FIG. 5.

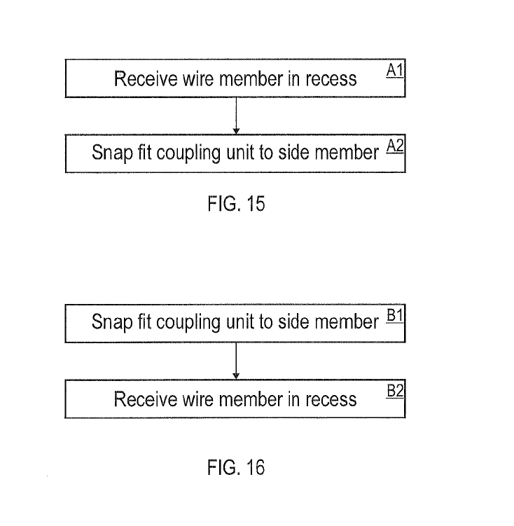

FIG. 15 is a flowchart of a method according to various embodiments. First, at A1, one or more wire members 111 are received in corresponding recesses 202. E.g., the recesses 202 can provide snap-in clip functionality; then, the one or more wire members 111 can be fixedly attached to the corresponding recesses 202 by a further snap fit.

Optionally, at A1, the wire members 111 may be mounted to the body 201 via the mount 213. This may include forming ends of the wire members 111 to hooks or knots and/or attaching a hook-member to the ends of the wire members 111; the ends of the wire members 111 can then be fixedly mounted to the mount 213.

Next, at A2, one or more coupling units 200 are snap fitted to the elongated side member 291. Generally, it is possible that per coupling unit 201 a single snap fit action is required. Where a single coupling unit 200 comprises a plurality of recesses 202, it is possible that per snap fit action a plurality of wire members 111 can be connected to the elongated side member 291.

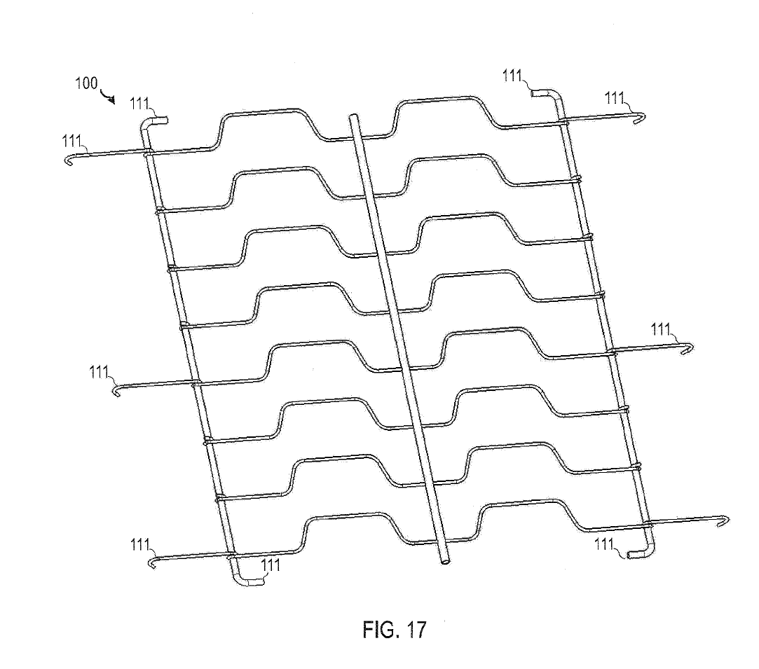

FIG. 16 is a flowchart of a method according to various embodiments. First, at B1, one or more coupling units 200 are snap fitted to the elongated side member 291. As such, B1 corresponds to A2 of FIG. 15.

Next, at B2, one or more wire members 111 are received in corresponding recesses 202. As such, B2 corresponds to A1 of FIG. 10.

As can be seen from the above, it is possible that the one or more wire members 111 are received in the corresponding recesses 202 before or after the coupling unit 200 is snap fitted to the elongated side member 291. Thereby, the flexibility in the assembly process of the support structure 100 in the seat frame 1000 can be increased.

FIG. 17 shows a wiremat suspension, e.g., implementing a back support structure in a seat. As can be seen, for installing the wiremat suspension support structure 100 in the backrest of the seat, the wiremat suspension support structure 100 comprises lateral and transversal wire members 111. At least some of the wire members 111 can be attached to an elongated side member of the frame of the seat (not shown in FIG. 17). Typically, the wire members 111 are comparably rigid such that it is possible to fixedly arrange the lumbar support structure 100 at a given position of the seat. Typically, the lateral wire members 111 (depicted in the left-right direction of FIG. 17) are attached to the elongated side member of the seat. Typically, the transversal wire members 111 (depicted in the up-down direction of FIG. 17) are plastified, i.e., covered by a plastic coating. Typically, the transversal wire members 111 are not connected to the elongated side member of the frame of the seat, albeit this is also possible in some scenarios. Sometimes the transversal wire members are referred to as borderwires.

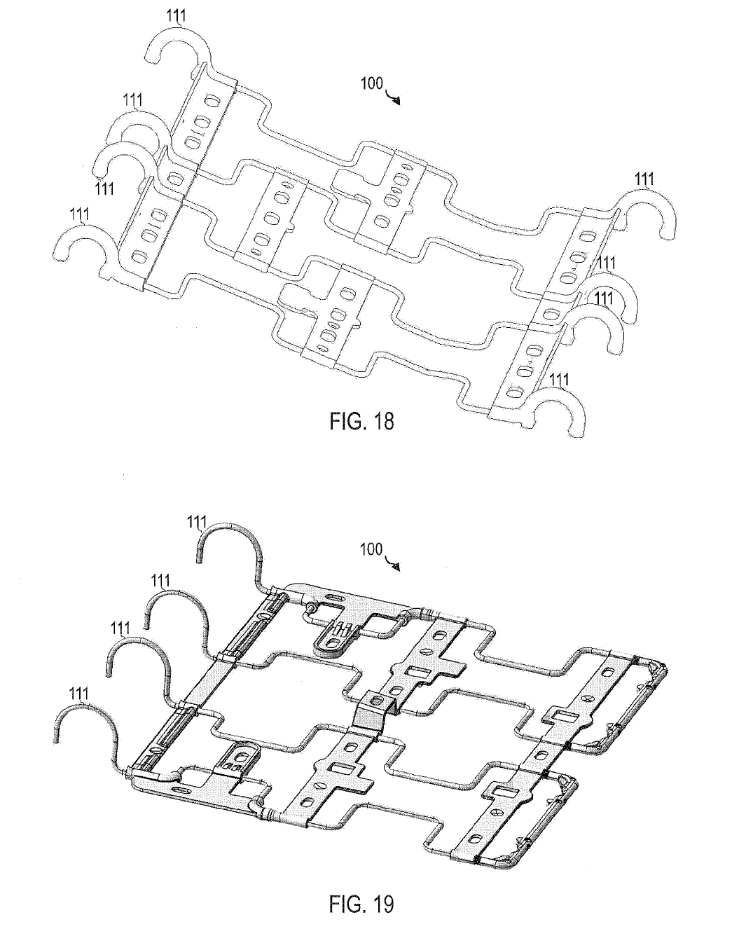

FIG. 18 shows a cushion support structure 100, e.g., implementing a seating support structure in a seat. As can be seen, for installing the cushion support structure 100 in the seating area of the seat, the cushion support structure 100 comprises lateral wire members 111. The wire members 111 can be attached to an elongated side member of the frame of the seat (not shown in FIG. 18). Typically, the wire members 111 are comparably rigid such that it is possible to fixedly arrange the lumbar support structure 100 at a given position of the seat. In the scenario of FIG. 18, ends of the wire members 111 are plastified, i.e., are covered by a plastic coating. The plastic coating is optional. By providing the plastic coating, a reliable attachment between the wire members 111 and the coupling unit (not shown in FIG. 18) can be achieved. The plastic coating further increases a stability and durability of the wire members 111.

FIG. 19 shows a cushion support structure 100 that is comparable to the cushion support structure 100 of FIG. 18; however, the wire members 111 are not plastified, i.e., are not covered by a plastic coating. This facilitates the insertion into the recess of the coupling unit (not shown in FIG. 19).

Summarizing, above techniques have been illustrated which enable to conveniently and reliably connect one or more wire members of a support structure to an elongated side member, e.g., of a seat frame or the like. The techniques rely on a snap fit. In particular, a coupling unit comprising a body is used as an intermediate element to provide the connection. In examples it is possible to snap fit the body of the coupling unit directly over and around the elongated side member; here, the coupling unit may act as a snap-on clip.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

E.g., while above reference has been primarily made to an elongated side member of a seat frame, similar techniques may be readily applied to other kinds and types of frames, e.g., for bedding applications including mattresses, furniture applications, etc.

E.g., while above various scenarios have been described with respect to the connection between the support structure and the elongated side member being made by a snap fit, generally it is possible to supplement the snap fit by further connection techniques. E.g., in some embodiments it may be possible that in addition to the snap fit the support structure is connected to the elongated side member also by a screw coupling. E.g., at least one of the coupling unit and the elongated side member may have a threading into which a corresponding screw may be screwed. Via the screw, the screw coupling can be established. The screw coupling can further add strengthen the connection between the support structure and the side member. The screw coupling can further limit the degrees of freedom of the movement of the support structure with respect to the side member.

1-32. (canceled)

33. A coupling unit for connecting a support structure to an elongated side member, the coupling unit comprising:
a body; and
at least one recess, each recess of the at least one recess configured to receive a wire member of the support structure,
wherein the coupling unit is configured to be connected to the elongated side member by a snap fit.

34. The coupling unit of claim 33, further comprising a passage formed in the body and shaped to at least partly enclose the elongated side member.

35. The coupling unit of claim 34, wherein the passage is shaped to at least partly enclose the elongated side member having a tubular shape.

36. The coupling unit of claim 35, wherein the passage is circularly shaped.

37. The coupling unit of claim 36, wherein an inner surface of the body forming the passage is configured to allow for rotational movement of the coupling unit with respect to the elongated side member.

38. The coupling unit of claim 34, wherein the passage is shaped to at least partly enclose the elongated side member having a plate shape.

39. The coupling unit of claim 34, wherein each recess of the at least one recess is tangentially arranged with respect to a center axis of the passage.

40. The coupling unit of claim 34, wherein the body is shaped to provide flexibility between opposing edges of the body forming the passage to provide the snap fit.

41. The coupling unit of claim 34, wherein the passage and the body are configured to act as a snap-on clip around the elongated side member.

42. The coupling unit of claim 33, wherein a material of the body has an elasticity configured to provide the snap fit.

43. The coupling unit of claim 33, further comprising a connector attached to the body and configured to provide the snap fit by a barb-hook engagement with the elongated side member.

44. The coupling unit of claim 33, further comprising a locking mechanism attached to the body,
wherein the body includes a first part and a second part, the first part and the second part forming a passage that is shaped to at least partly enclose the elongated side member in an attachment position, and
wherein the locking mechanism is configured to connect the first part and the second part by the snap fit in the attachment position.

45. The coupling unit of claim 44, wherein the locking mechanism is configured to provide the snap fit by a barb-hook engagement between the first part and the second part.

46. The coupling unit of claim 33, wherein the body is arc-shaped.

47. The coupling unit of claim 46, wherein the arc-shaped body extends at an angle in the range of 160° to 200°.

48. The coupling unit of claim 33, further comprising a stop shaped to limit at least one of a rotational movement or a translational movement of the coupling unit with respect to the elongated side member.

49. The coupling unit of claim 48, wherein the stop includes at least one of a protrusion or a notch.

50. The coupling unit of claim 48, wherein the stop comprises a contact surface.

51. The coupling unit of claim 33, further comprising a mount configured to fixedly mount the wire member to the body.

52. The coupling unit of claim 33, wherein each recess of the at least one recess is shaped to be tangentially arranged with respect to a longitudinal axis of the elongated side member, and
wherein each recess of the at least one recess is shaped to extend at an angle in the range of 20° to 180° with respect to the longitudinal axis of the passage.

53. The coupling unit of claim 52, wherein each recess of the at least one recess is shaped to extend at an angle in the range of 50° to 160° with respect to the longitudinal axis of the passage.

54. The coupling unit of claim 33, wherein a material of the body is plastic.

55. The coupling unit of claim 33, further comprising an interface configured to establish an electrical interconnection with electronic wiring.

56. The coupling unit of claim 33, wherein each recess of the at least one recess is configured to receive the respective wire member by a further snap fit.

57. A system comprising a plurality of coupling units according to claim 33.

58. The system of claim 57, further comprising an elongated joint shaped to extend in parallel with a longitudinal axis of the elongated side member and configured to connect the plurality of coupling units.

59. A seat structure comprising the coupling unit according to claim 33 and a seat frame comprising the elongated side member.

60. The seat structure of claim 59, further comprising the support structure.

61. The seat structure of claim 60, wherein the support structure is a lumbar support structure.

62. The seat structure of claim 60, wherein the support structure is a wiremat support structure.

63. A method comprising:
receiving a wire member in a recess of a coupling unit; and
snap fitting the coupling unit to an elongated side member.

64. The method of claim 63, wherein the receiving is executed before the snap fitting.

65. The method of claim 63, wherein the receiving is executed after the snap fitting.
